(19) United States
(12) Patent Application Publication
(10) Pub. No.: US 2025/0302053 A1
(43) Pub. Date: Oct. 2, 2025

(54) Automatic Crepe Making Device

(71) Applicant: Richard Demartini, Wiesbaden (DE)

(72) Inventor: Richard Demartini, Wiesbaden (DE)

(21) Appl. No.: 19/055,524

(22) Filed: Feb. 18, 2025

Related U.S. Application Data
(60) Provisional application No. 63/573,141, filed on Apr. 2, 2024.

(51) Int. Cl. A21B 5/03; A47J 27/00; A47J 36/02; A47J 36/32

(52) U.S. Cl. CPC A21B 5/03; A47J 27/004; A47J 36/025; A47J 36/32

(57) ABSTRACT

An automatic crepe making device is provided. The automatic crepe making device includes a base with a motor-operated turntable and a heating element, a rotatable cooking surface that can rest on the turntable, and a lifting assembly extending from the base. The lifting assembly is movable between a resting position and a lifting position to engage with the edge of the cooking surface, raising and tilting it during rotation. This motion causes crepe batter to spread evenly across the surface, creating a thin, consistent layer without manual intervention. A control mechanism adjusts the turntable's rotation speed and the heating element's temperature, allowing customization for different batter types and textures. Indicator lights signal the readiness of the cooking surface, and an automatic shutoff enhances safety.

### CROSS REFERENCE TO RELATED APPLICATION

This application claims the benefit of pending U.S. provisional application No. 63/573,141 filed on Apr. 2, 2024; the above identified patent application is herein incorporated by reference in its entirety.

### BACKGROUND OF THE INVENTION

The present invention relates to automated cooking devices. More specifically, the present invention provides an automated crepe-making device that facilitates the preparation of crepes with minimal user intervention while ensuring consistent results.

Crepes are a popular culinary staple, enjoyed in both sweet and savory variations across the globe. Traditionally, crepe preparation requires significant skill and precision, as achieving the desired thinness and uniformity of the crepe batter demands manual expertise. The process involves pouring batter onto a hot pan, spreading it evenly into a thin layer, and flipping the crepe once it is partially cooked. This requires not only specialized tools, such as crepe spreaders, but also a level of dexterity that can be challenging for inexperienced users.

Over time, the market has seen the introduction of various devices aimed at simplifying the process of making crepes. For instance, some devices feature pans with non-stick surfaces and ergonomically designed batter spreaders to aid in spreading the batter. While these solutions address some challenges, they still require significant user involvement, particularly in manually spreading the batter to achieve the characteristic thinness of crepes. Additionally, many of these devices lack the ability to ensure consistent results across multiple crepes, as the process is still highly dependent on user technique and timing.

A further limitation of existing devices is the lack of flexibility in adjusting settings to suit different batter types or desired crepe textures. Crepes vary widely in thickness, consistency, and cooking requirements, yet most currently available devices offer limited customization options. This makes it difficult for users to achieve optimal results for specific recipes. Moreover, some devices are cumbersome to clean or maintain, with complex mechanisms that deter regular use.

These shortcomings highlight the need for an automated crepe-making device that eliminates the need for manual batter spreading while maintaining high-quality, consistent results. Such a device would need to simplify the process for both experienced chefs and novice users, offering intuitive controls and the ability to customize cooking parameters to suit various recipes. Existing devices also fail to incorporate features that enhance convenience, such as removable components for easy cleaning, safety mechanisms, and intuitive indicators for operation.

The present invention addresses these challenges by introducing an automated crepe-making device that combines rotation, heating, and vertical motion to achieve the even spreading of crepe batter without manual intervention. The present invention eliminates the reliance on manual spreading tools and significantly reduces the skill required to prepare high-quality crepes. Additionally, the device offers customizable controls for temperature and rotation speed, enabling users to tailor the cooking process to their specific needs. By addressing the limitations of known art, the present invention provides an efficient, user-friendly solution that makes crepe preparation accessible and enjoyable for all.

In light of the devices disclosed in the known art, it is submitted that the present invention substantially diverges in design elements and methods from the known art and consequently it is clear that there is a need in the art for an improvement for an automatic crepe making device. In this regard the instant invention substantially fulfills these needs.

### SUMMARY OF THE INVENTION

In view of the foregoing disadvantages inherent in the known types of automatic crepe making devices now present in the known art, the present invention provides a new automatic crepe making device wherein the same can be utilized for cooking a crepe by automatically rotating a pan while tilted for evenly spreading crepe batter while cooking.

It is an objective of the present invention to provide an automatic crepe making device comprising a base with a motor-operated turntable and a heating element. The motor-operated turntable rotates the cooking surface while the heating element provides consistent heat to ensure even cooking of the crepe batter. This configuration eliminates the need for manual batter spreading and reduces the skill required to prepare high-quality crepes, making the process accessible to users of varying culinary experience levels.

It is an objective of the present invention to provide an automatic crepe making device equipped with a lifting assembly that engages the edge of the cooking surface to tilt and wobble the surface during rotation. The combination of rotation and tilting creates a uniform layer of batter without manual intervention.

It is an objective of the present invention to provide an automatic crepe making device with a customizable control mechanism for adjusting the temperature of the heating element and the rotation speed of the turntable. This allows users to tailor the cooking process to different batter types and desired crepe textures. The customizable controls enhance the versatility of the device, enabling consistent results across a wide variety of crepe recipes.

It is an objective of the present invention to provide an automatic crepe making device with indicator lights to signal the preheating and readiness status of the cooking surface. A red light indicates when the surface is heating, while a green light signals that the optimal temperature has been reached.

It is an objective of the present invention to provide an automatic crepe making device with a removable cooking surface for ease of cleaning and maintenance. The removable design simplifies post-cooking cleanup, making the device more practical for regular use.

It is an objective of the present invention to provide an automatic crepe making device with safety features, such as an automatic shutoff mechanism that deactivates the device after a cooking cycle is complete. The automatic shutoff enhances safety by preventing overheating and conserving energy.

It is an objective of the present invention to provide an automatic crepe making device with a durable and compact design. The device is constructed to withstand frequent use while occupying minimal counter space, ensuring practicality for users with limited kitchen space.

It is therefore an object of the present invention to provide a new automatic crepe making device that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of an embodiment of the automatic crepe making device in a lifting position.

FIG. 2 shows a side view of an embodiment of the automatic crepe making device in a lifting position.

FIG. 3 shows a perspective view of the lifting assembly of an embodiment of the automatic crepe making device in a resting position.

FIG. 4 a perspective view of a first alternate embodiment of the automatic crepe making device.

FIG. 5 shows a perspective view of a second alternate embodiment of the automatic crepe making device in a resting position.

FIG. 6 shows a block diagram of an embodiment of the automatic crepe making device.

### DETAILED DESCRIPTION OF THE INVENTION

Reference is made herein to the attached drawings. For the purpose of presenting a brief and clear description of the present invention, the preferred embodiment will be discussed as used for automatically cooking a crepe. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

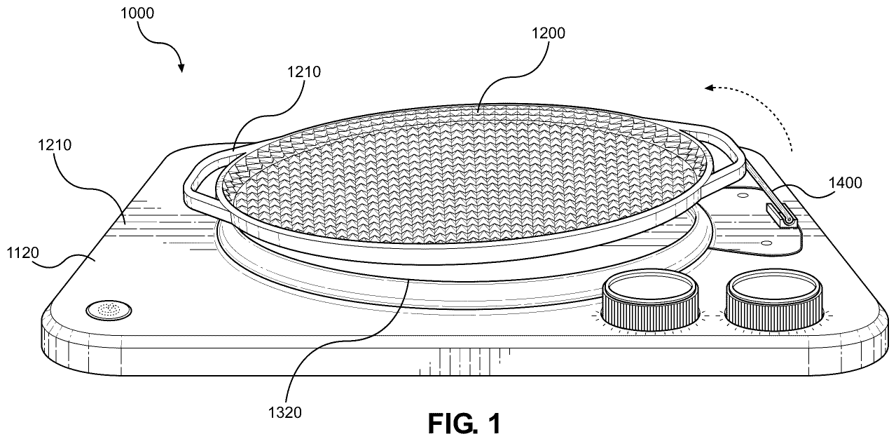

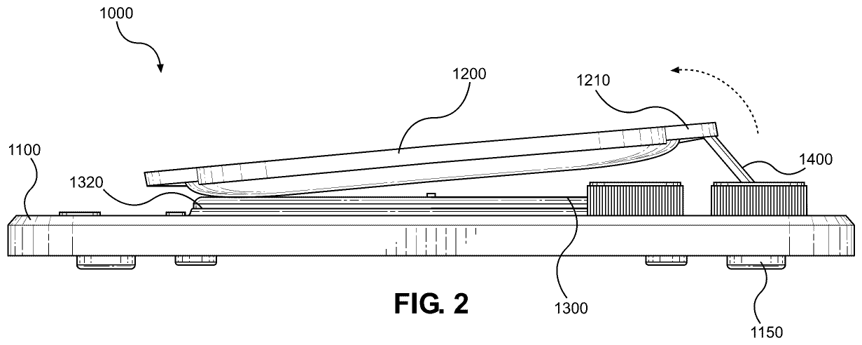

Referring now to FIGS. 1 and 2, there is shown a perspective view and a side view of an embodiment of the automatic crepe making device, respectively. In the illustrated embodiment, the automatic crepe making device 1000 comprises a base 1100 having a motor-operated turntable and a heating element disposed within the base 1100. The base 1100 is configured to provide a compact and stable foundation for the operation of the device. In the shown embodiment, the base 1100 is thin and lightweight, allowing it to fit conveniently on a countertop without occupying excessive space, as well as providing portability for a user to easily carry the device. In the illustrated embodiment, the base has a rectangular shape, but it is not limited to this configuration and may comprise any suitable shape, such as circular, square, or oval, depending on design preferences or functional requirements. The base 1100 is constructed from durable, heat-resistant materials to ensure user safety and longevity of the device. The base 1100 houses the motor, heating element and power connections, which are enclosed to prevent accidental contact and maintain a sleek exterior profile. In some embodiments, the outer casing of the base 1100 is insulated to protect against heat transfer, ensuring the device remains cool to the touch during operation. In some embodiments, the base is equipped with non-slip feet or pads 1150 on the bottom surface to prevent movement during use.

The automatic crepe making device comprises a heating member configured to receive the crepe batter directly thereon for cooking. In the illustrated embodiment, the heating member is a rotatable pan 1200, wherein the pan 1200 is configured to rest on the turntable 1300 and is heated by the heating element. The rotation and tilting of the pan 1200 causes crepe batter poured into the pan to spread into a thin, even layer with minimal user input. The pan 1200 is circular and comprises a flat bottom. The shape of the pan facilitates a smooth rotation when a lifting assembly 1400 is engaged with an edge of the pan 1200. In the illustrated embodiment, the pan 1200 comprises two handles 1210 disposed on opposing sides thereof, wherein each handle is adapted to engage with the lifting assembly 1400 as the pan 1200 rotates on the turntable 1300. In the illustrated embodiment, each handle comprises a U-shape having a pair of ends extending from a perimeter of the pan 1200, forming a central opening for receiving a hand therethrough. The configuration and position of the handles 1210 enables both a rocking and side to side motion as the pan 1200 rotates and when engages with the lifting assembly 1400.

The pan 1200 is retained on the turntable 1300 when tilted, by a raised lip 1320 extending around the perimeter of the turntable 1300, forming a shallow recess that aligns with the bottom of the pan. The bottom side of the pan 1200 slidably fits within the inside of the perimeter of the turntable 1300 defined by the raised lip 1320. The raised lip 1320 serves as a containment feature, preventing unintended movement or displacement of the pan during operation. The interaction between the raised lip 1320 and the rounded bottom of the pan 1200 facilitates smooth rotation without excessive lateral shifting, ensuring even heat distribution and consistent batter spreading. Additionally, the design prevents the pan from slipping off the turntable when the lifting arm tilts the pan at an angle during operation. This arrangement enables the pan to remain in controlled motion while allowing for removal for cleaning or batter preparation. In alternate embodiments, the pan may include an extension rim or a slightly recessed bottom to further enhance its stability on the turntable while maintaining ease of removal.

The turntable 1300 is mounted within the base 1100 and is driven by the motor, which controls its rotational speed. The turntable is circular in shape to match the contours of the cooking pan, though alternate shapes may be used to accommodate variations in pan design. The turntable is made of a heat-resistant, durable material, such as stainless steel or high-temperature-resistant plastic, to withstand continuous heating and mechanical movement.

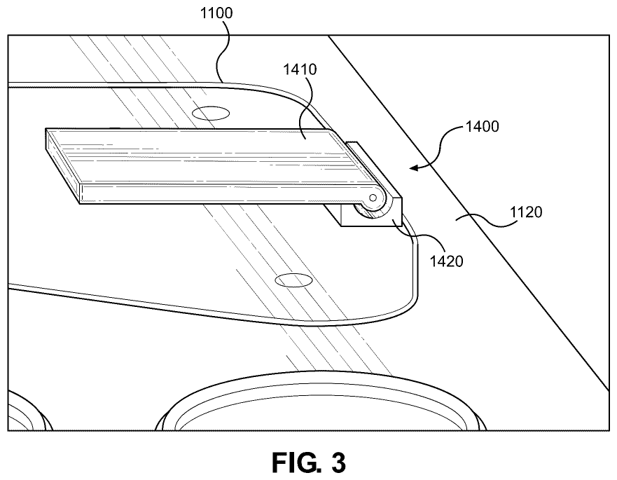

Referring now to FIGS. 1-3, there is shown the perspective view and a side view of an embodiment of the automatic crepe making device and the lifting assembly 1400 is configured to engage an edge of the pan 1200 and raise the edge away from the base during rotation. The lifting assembly 1400 extends from an upper side 1120 of the base 1100, wherein the lifting assembly is movable between a resting position and a lifting position. In the illustrated embodiment, the lifting assembly 1400 comprises a flat arm 1410 that pivots about a horizontal axis of a support member 1420 that rests on the base 1100. The arm 1410 is configured to rotate or pivot from the resting position to the lifting position. In the resting position, the arm 1410 is substantially parallel to the base 1100 such that the distal end of the arm 1410 is positioned or aligned with an edge of the pan or handle thereof such than when the lifting assembly transitions to the lifting position, the distal end of the arm 1410 engages with the pan or handle thereof. In the lifting position, an interior angle of less than 90 degrees is formed between the base 1100 and the arm 1410. In alternate embodiments, a flange extends entirely around the perimeter of the pan and adapted to engage with the lifting assembly. In this way, the arm is continuously engaged with the pan when in a lifting position.

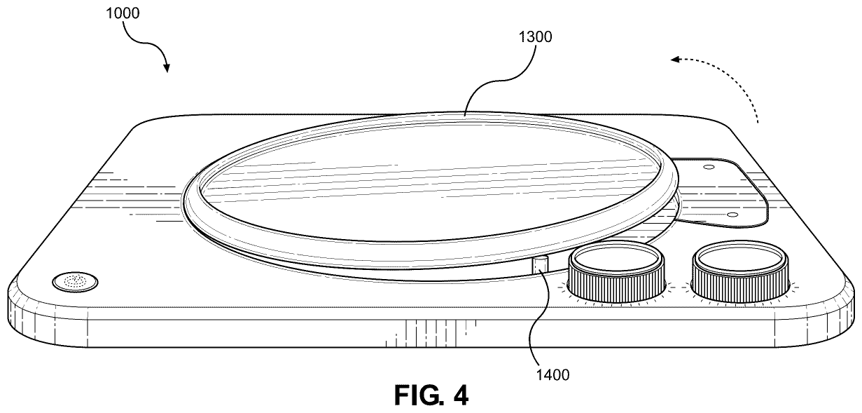

Referring now to FIG. 4, there is shown a first alternate embodiment of the automatic crepe making device. In some embodiments, the automatic crepe making device 1000 does not include a removable pan. Instead, the turntable 1300 serves as the heating member for the crepe, eliminating the need for a removable pan. The heated turntable is directly coupled to a rotational motor housed within the base, providing continuous motion to facilitate the even spreading of crepe batter. To enable safe and efficient power transfer to the rotating heated surface, the motor is connected through a through-hole electrical slip ring assembly to allow uninterrupted electrical flow while allowing full rotation of the heated surface.

The lifting assembly is positioned beneath the heated turntable, rather than externally engaging the edge of a removable pan. The lifting assembly is integrated into the base and is partially hidden from view, preserving the sleek, compact design of the device. To allow for controlled lifting and return to a stable horizontal position, the heated turntable is mounted on a rubber resilient mount fitting, which provides both flexibility and controlled motion dampening. This resilient mount enables the surface to be lifted by the arms and gently return to its original position, ensuring smooth and consistent tilting movements. The location of the lifting assembly beneath the turntable ensures that the lifting components remain unobtrusive and do not interfere with batter application or crepe removal. In other embodiments, the lifting assembly is any suitable mechanism such as a cam-based mechanism, a solenoid-activated lifting system, a pneumatic or hydraulic lifting actuators, a spring-loaded oscillation with motorized trigger, a magnetic tilting mechanism, among other mechanisms.

In the cam-based embodiment, a camshaft system is positioned beneath the turntable and is configured to provide controlled vertical movement. The cams comprise gradual slopes, and as they rotate, they are configured to periodically push up specific points along the circumference of the turntable, causing a smooth tilting motion. Once the high point of the cam passes, the surface returns to its horizontal position, aided by the resilient mount or gravity.

The solenoid-activated lifting system embodiment comprises electromagnetic actuators adapted to engage the turntable at specific time intervals to lift designated points of the turntable. The solenoids could be placed at opposing edges of the heated surface to create an alternating tilting motion, mimicking the manual spreading action. In some embodiments, a pneumatic or hydraulic system is incorporated within the base to provide smooth, fluid tilting movement. Small air or hydraulic pistons could be positioned beneath the turntable, inflating and deflating in controlled sequences to create a wobbling or tilting effect.

In the spring-loaded oscillation with motorized trigger embodiment, the lifting assembly comprises a spring configured to bias the turntable in a neutral position, with a small motor periodically engaging a push-arm or lever to induce a controlled lifting motion. When the motor activates, it briefly compresses the spring mechanism, lifting one edge of the surface before releasing it back into a neutral position.

In the magnetic tilting mechanism embodiment, the lifting assembly comprises electromagnetic coils positioned underneath the turntable. When activated, the coils generate localized magnetic fields that interact with embedded ferromagnetic elements within the turntable, causing precise lifting or tilting actions.

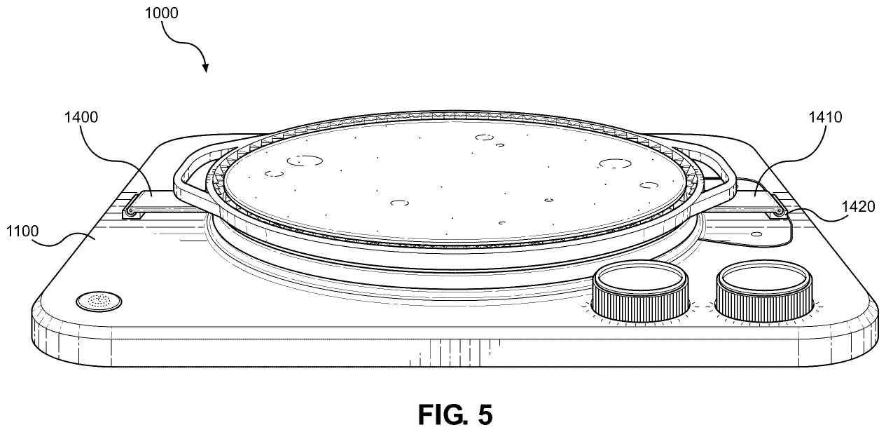

Referring now to FIG. 5, there is shown a perspective view of a second alternate embodiment of the automatic crepe making device in a resting position. In the illustrated embodiment, the lifting assembly 1400 of the automatic crepe making device 1000 comprises a pair of arms 1410 and support members 1420 extending from opposite sides of the base 1100 and are configured to engage designated contact points along the circumference of the pan. Each arm is connected to a support member, which extends outwardly from the base and provides a stable pivot point for controlled lifting motion. During operation, the lifting arms alternately raise and lower specific sections of the heated surface, creating a tilting effect that evenly distributes the batter across the cooking surface. The lifting motion is synchronized with the rotation of the surface to ensure a uniform spread without manual intervention. The lifting arms may be actuated through mechanical linkages, motors, or pneumatic actuators, allowing for precise control over the tilting angle and frequency. This embodiment provides reliable, repeatable batter spreading, while the placement of the support members on opposite sides of the base allows for balanced lifting motion without excessive strain on any single lifting arm.

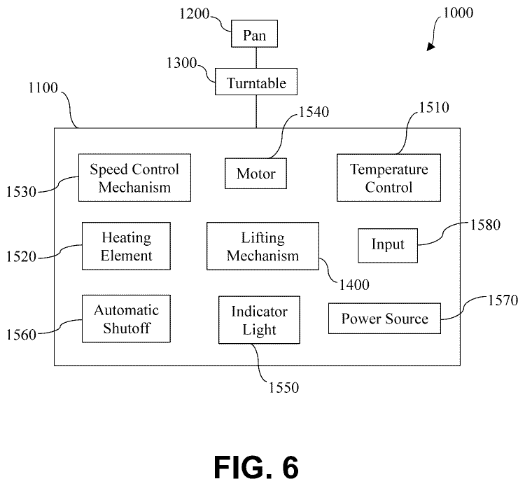

Referring not to FIG. 6, there is shown a block diagram of an embodiment of the automatic crepe making device. The automatic crepe making device 1000 comprises a control interface 1500 comprising a temperature control mechanism 1510 operably connected to the heating element 1520 and a rotation speed control mechanism 1530 operably connected to the motor 1540 of the turntable 1300. An indicator light 1550 is disposed on the base 1100 to indicate to a user when the heating element 1520 has reached a pre-determined temperature and/or is in the process of heating to a predetermined temperature. In some embodiments, the automatic crepe making device comprises an automatic shutoff member 1560 that engages when a crepe cooking cycle is complete.

In the illustrated embodiment, the heating element may be an electric resistance coil embedded within the base of the device, positioned directly beneath the rotatable pan or integrated heated turntable. This coil generates heat when an electrical current passes through it, transferring thermal energy evenly to the cooking surface to ensure uniform batter cooking. The heating element can be configured in a spiral or concentric ring pattern to maximize heat distribution across the entire surface area.

In alternative embodiments, the heating element may be a ceramic infrared heater, which emits radiant heat to quickly and efficiently warm the cooking surface. Infrared heating elements are advantageous for rapid heating and maintaining consistent temperatures without significant fluctuations. Additionally, the heating element could be a flat heating plate made of conductive metal, such as aluminum or stainless steel, integrated directly into the underside of the turntable. This design allows the cooking surface itself to act as a heat conductor, eliminating the need for a separate pan and reducing heat loss.

In some embodiments, a power source 1570 is disposed within the base and operably connected to the heating element 1520 and motor 1540. In the illustrated embodiment, the power source 1570 comprises a battery disposed within the base. In alternate embodiments, the base comprises an input 1580 or connection that enables the automatic crepe making device to connect to an external power source.

In an alternative embodiment, the control mechanism may feature a single, integrated control that combines both temperature adjustment and rotation speed (RPM) settings into a unified interface. In some embodiments, the rotational speed preset detents at 40, 50, and 60 RPM for ease of selection. In this configuration, the control simplifies user interaction by allowing for adjustments without requiring separate controls for heat and rotation. The integrated control operates through a logic circuit, which dynamically adjusts the rotation speed based on the selected temperature. For example, at lower temperature settings, the rotation speed is reduced, while at higher temperatures, the rotation speed increases, ensuring optimal spreading and cooking conditions based on the viscosity and type of batter used. This automated synchronization between heat and rotation provides ease of use and allows for consistent crepe quality without requiring manual fine-tuning.

The control mechanism may take the form of any suitable actuator, such as a rotating knob or a sliding interface. A rotary dial allows for gradual adjustments, while a slider-based control may provide a more linear and intuitive method of setting the desired combination of temperature and speed. The control interface may also be positioned in different locations on the device, such as the top surface, side panel, or front face, depending on ergonomic considerations and design preferences.

In operation, the automatic crepe making device 1000 is activated when a user activates the power and sets the desired temperature and rotation speed using the control mechanism. In one embodiment, the power control once selected, illuminates red when activated and remains illuminated for the entire duration of operation, providing a clear visual indication that the device is powered on. When the temperature control selector is engaged, a red temperature indicator light activates, signaling that the heating element is warming the cooking surface to the preselected temperature. Once powered on, the heating element within the base starts warming the rotating cooking surface, and an indicator light signals when the surface has reached the selected temperature. For example, once the cooking surface reaches the desired temperature, the red temperature indicator light automatically turns off, and a green temperature indicator light illuminates, indicating that the pan is fully heated and ready for batter application. When the cooking surface is sufficiently heated, the user pours crepe batter onto it, and the motor-driven turntable initiates rotation. As the surface rotates, the lifting assembly-whether in the form of a lifting arm, concealed tilting mechanism, or paired support arms-engages with the edge or underside of the cooking surface to create a controlled tilting motion. This tilting, combined with the rotation, causes the batter to spread evenly across the surface, eliminating the need for a manual spreading tool. The lifting and simultaneous rotation causes gravity to distribute the batter to the edges to cover an interior side of the heating member.

During the cooking process, the user can monitor the crepe's progress and adjust settings as needed. The controlled heating ensures even cooking, preventing hot spots or uneven browning. If included, an automatic shutoff feature disengages the heating element and motor once a preset cooking cycle is complete. The user can then lift or slide the cooked crepe off the non-stick cooking surface. In embodiments where the cooking surface is removable, the user can detach it for easy cleaning. In alternative designs with an integrated heated turntable, the surface can be wiped clean directly. By automating the batter spreading and cooking process, the device reduces manual effort and skill requirements, ensuring consistent, high-quality crepes with minimal user input.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An automatic crepe making device, comprising:
a base having a motor-operated turntable and a heating element;
a heating member operably connected to the heating element and configured to provide heat thereto;
a lifting assembly movable between a resting position and a lifting position, wherein the lifting assembly is configured to engage the heating member and raise an edge thereof away from the base;
a control interface comprising a temperature control mechanism operably connected to the heating element and a rotation speed control mechanism operably connected to a turntable having a motor;
wherein the turntable is configured to rotate the heating member;
wherein the rotation of the turntable and movement of the lifting assembly are used simultaneously to spread crepe batter into a thin, even layer on the heating member via gravity.

2. The device of claim 1, further comprising an indicator light configured to display a red light when the heating element is preheating and display a green light when the heating element has reached a preset temperature.

3. The device of claim 1, further comprising a plurality of non-slip pads extending from a bottom surface of the base.

4. The device of claim 1, further comprising a power source disposed within the base and operably connected to the heating element and the motor.

5. The device of claim 1, further comprising an automatic shutoff mechanism configured to deactivate the device after a cooking cycle is complete.

6. The device of claim 1, wherein the heating member is a pan configured to rest on the turntable.

7. The device of claim 6, wherein the rotatable pan comprises a circular shaped cross section.

8. The device of claim 6, wherein the pan is retained on the turntable by a raised lip extending around the perimeter of the turntable, forming a shallow recess for securing the pan during rotation and tilting.

9. The device of claim 1, wherein the lifting assembly is configured to tilt the heating member to a predetermined angle during rotation to optimize batter spreading.

10. The device of claim 1, wherein the control interface combines the temperature and rotation speed dials into a single control knob with logic circuitry that adjusts rotation speed based on the selected temperature.

11. The device of claim 1, wherein the heating member is an upper surface of the turntable and the turntable is non-removable from the base.

12. The device of claim 1, wherein the lifting assembly comprises a flat arm that pivots about a horizontal axis of a support member, which rests on the base, wherein the arm is adapted to transition between the resting position and the lifting position upon actuation thereof.

13. The device of claim 12, further comprising two lifting assemblies positioned at opposing sides of the heating member, configured to intermittently raise and lower the heating member during rotation.

14. The device of claim 12, wherein in the lifting position, the lifting arm forms an interior angle of less than 90 degrees relative to the base and the heating member.

15. The device of claim 1, wherein the lifting assembly comprises a lifting arm positioned between the base and the turntable to achieve vertical lifting of an edge of the cooking member and tilting of the cooking member such that it is positioned at an inclined angle relative to a horizontal plane of the base.

16. The device of claim 1, wherein the lifting assembly is concealed within the base during a resting position and operates through a rubber resilient mount fitting.

17. The device of claim 1, wherein the heating member comprises a non-stick coating to prevent batter adhesion and facilitate crepe removal.

18. The device of claim 1, wherein the control mechanism dynamically adjusts rotation speed based on a selected temperature setting, wherein higher temperatures increase rotation speed and lower temperatures decrease it.

19. The device of claim 1, further comprising a timer mechanism configured to automatically deactivate the heating element and the motor after a preset duration.

20. The device of claim 1, wherein the lifting assembly raises the heating member during rotation.
